(19) United States
(12) Patent Application Publication
(10) Pub. No.: US 2018/0085281 A1
(43) Pub. Date: Mar. 29, 2018

(54) WALKING ASSISTANCE DEVICE AND METHOD FOR OPERATING THE SAME

(71) Applicant: Samsung Electronics Co., Ltd., Suwon-si (KR)

(72) Inventor: ChangHyun ROH, Seongnam-si (KR)

(73) Assignee: Samsung Electronics Co., Ltd., Suwon-si (KR)

(21) Appl. No.: 15/403,546

(22) Filed: Jan. 11, 2017

(30) Foreign Application Priority Data
Sep. 26, 2016 (KR) 10-2016-0122875

(51) Int. Cl. A61H 3/06; A45B 3/08

(52) U.S. Cl. CPC A61H 3/06; A61H 2003/007; A45B 3/08

(57) ABSTRACT

A method and apparatus for controlling at least one vibration element disposed on a sole of a user, an apparatus for providing a walking assistance force for a user may calculate a torque of an assistance force based on walking information of the user, calculate a physical quantity of a property of at least one vibration element based on the torque when the apparatus generates the torque, and control the vibration element based on the calculated physical quantity is provided.

### CROSS-REFERENCE TO RELATED APPLICATION

This application claims under 35 U.S.C. § 119 to Korean Patent Application No. 10-2016-0122875, filed on Sep. 26, 2016, in the Korean Intellectual Property Office, the entire contents of which are incorporated herein by reference in their entirety.

### BACKGROUND

### 1. Field

At least one example embodiment relates to a walking assistance device and/or a method for operating the same. For example, at least some example embodiments relate to a walking assistance device including a shoe insole having a vibration device and/or a method of operating the same.

### 2. Description of the Related Art

There being a number of rapidly aging societies, many people may experience inconvenience and/or pain from joint problems. Thus, there is a growing interest in walking assistance devices that enable the elderly and/or patients having joint problems to walk with less effort. Furthermore, walking assistance devices for intensifying muscular strength of human bodies may be useful for military purposes.

### SUMMARY

Some example embodiments relate to a method of operating a walking assistance device, the walking assistance device configured to provide an assistance force to assist a user with walking.

In some example embodiments, the method may include calculating a torque of the assistance force based on walking information associated with the user, the walking information being obtained through at least one sensor; calculating a physical quantity of a property of at least one vibration element based on the torque, the at least one vibration element being proximate to a sole of the user; and controlling the at least one vibration element based on the physical quantity.

In some example embodiments, the property of the physical quantity includes one or more of an amplitude and a frequency of vibration of the at least one vibration element.

In some example embodiments, the controlling includes controlling the at least one vibration element via a wireless local area network.

In some example embodiments, the at least one vibration element is configured to fit within an insole of a shoe associated with the user.

In some example embodiments, the physical quantity is proportional to the torque.

In some example embodiments, the walking information includes at least one of information on an angle of a hip joint of the user and information on an angular velocity of the hip joint.

In some example embodiments, the controlling includes controlling the at least one vibration element such that the at least one vibration element operates at a point in time at which the torque is output.

In some example embodiments, the method further includes detecting an event; and controlling the at least one vibration element based on a physical quantity set for the event, if an occurrence of the event is detected.

In some example embodiments, the at least one sensor is a pressure sensor.

In some example embodiments, the walking information includes information associating a pressure applied to the pressure sensor by the user and a level of the torque, and the pressure sensor is included in a walking stick.

Some other example embodiments relate to a non-transitory computer-readable medium comprising computer readable instructions that, when executed by a computer, cause the computer to perform the method of operating a walking assistance device.

Some other example embodiments relate to a walking assistance device configured to provide an assistance force to assist a user with walking.

In some example embodiments, the walking assistance device includes at least one sensor configured to obtain walking information of a user; and a processor configured to, calculate a torque of the assistance force based on the walking information, calculate a physical quantity of a property of at least one vibration element based on the torque, the at least one vibration element being proximate to a sole of the user, and control the at least one vibration element based on the physical quantity.

In some example embodiments, the walking assistance device further includes a shoe insole, the at least one vibration element being configured to fit within the shoe insole.

In some example embodiments, the physical quantity is proportional to the torque.

In some example embodiments, the processor is configured to control the at least one vibration element such that the at least one vibration element operates at a point in time at which the torque is output.

In some example embodiments, the processor is configured to detect an event, and to control the at least one vibration element based on a physical quantity set for the event, if an occurrence of the event is detected.

In some example embodiments, the at least one sensor is a pressure sensor.

In some example embodiments, the walking assistance device further includes a walking stick including the pressure sensor, and wherein the walking information associating a pressure applied to the pressure sensor by the user and a level of the torque.

In some example embodiments, the walking assistance device further includes a global positioning system (GPS), wherein the processor is configured to set a movement route based on the GPS, and to control the at least one vibration element to indicate the movement route.

Some other example embodiments relate to a walking assistance device including a walking stick including a pressure sensor configured to detect a pressure applied by a user; a shoe insole including the at least one vibration element; and a processor configured to, calculate a torque of an assistance force to be provided for the user based on the pressure, calculate a physical quantity of a property of the at least one vibration element based on the torque, and control the at least one vibration element based on the physical quantity.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIGS. 1 and 2 each illustrate an example of a walking assistance device according to at least one example embodiment;

FIG. 3 illustrates another example of a walking assistance device according to at least one example embodiment;

FIG. 4 is a block diagram illustrating a walking assistance device according to at least one example embodiment;

FIG. 5 is a flowchart illustrating a method of operating a walking assistance device according to at least one example embodiment;

FIG. 6 illustrates a shoe insole according to at least one example embodiment;

FIG. 7 is a flowchart illustrating a method of controlling a vibration element based on an event according to at least one example embodiment;

FIG. 8 illustrates still another example of a walking assistance device according to at least one example embodiment;

FIG. 9 is a block diagram illustrating a device in a form of a stick according to at least one example embodiment;

FIG. 10 is a flowchart illustrating a method of receiving walking information using a pressure sensor according to at least one example embodiment; and

FIG. 11 is a flowchart illustrating a method of controlling a vibration element to show a movement route according to at least one example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

<Outline of Walking Assistance Device>

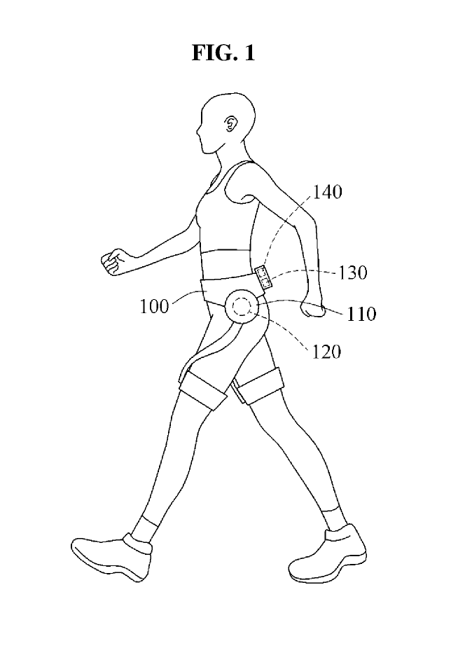

FIGS. 1 and 2 each illustrate a walking assistance device according to at least one example embodiment.

Referring to FIG. 1, a walking assistance device 100 is attached to a user to assist the user, for example, with walking. The walking assistance device 100 may be a wearable device.

Although FIG. 1 illustrates a hip-type walking assistance device, the type of the walking assistance device is not limited thereto. The walking assistance device may be applicable to a walking assistance device that supports an entire pelvic limb, and a walking assistance device that supports a portion of a pelvic limb. The walking assistance device that supports a portion of a pelvic limb may be applicable to a walking assistance device that supports up to a knee, and a walking assistance device that supports up to an ankle.

Example embodiments described with reference to FIG. 1 and so on may be applicable to a hip-type walking assistance device, but are not limited thereto. The example embodiments may be applicable to all devices that assist a user with walking.

The walking assistance device 100 includes a driving portion 110, a sensor portion 120, an inertial measurement unit (IMU) sensor 130, and a controller 140.

The driving portion 110 may drive a hip joint of a user. For example, the driving portion 110 may be disposed on a right hip portion and/or a left hip portion of the user.

The driving portion 110 may include a motor configured to generate a rotational torque.

The sensor portion 120 may measure an angle of the hip joint of the user while the user is walking. Information on the angle of the hip joint sensed by the sensor portion 120 may include an angle of a right hip joint, an angle of a left hip joint, a difference between the angle of the right hip joint and the angle of the left hip joint, and/or motion directions of both hip joints. For example, the sensor portion 120 may be disposed in the driving portion 110.

The sensor portion 120 may include a potentiometer. The potentiometer may sense an R-axis joint angle, an L-axis joint angle, an R-axis joint angular velocity, and/or an L-axis joint angular velocity with respect to a gait motion of the user.

The IMU sensor 130 may measure acceleration information and pose information while the user is walking. For example, the IMU sensor 130 may sense an X-axis acceleration, a Y-axis acceleration, a Z-axis acceleration, an X-axis angular velocity, a Y-axis angular velocity, and a Z-axis angular velocity with respect to the gait motion of the user.

The walking assistance device 100 may detect a point at which a foot of the user lands based on the acceleration information measured by the IMU sensor 130.

A pressure sensor (not shown) may be disposed on a sole of the user to detect the landing point of the foot of the user.

In addition to the sensor portion 120 and the IMU sensor 130, the walking assistance device 100 may include other sensors, for example, an electromyogram (EMG) sensor, configured to sense a change in a biosignal or a momentum of the user with respect to the gait motion.

The controller 140 may control the driving portion 110 to output an assistance force to assist the user with walking. For example, in the hip-type walking assistance device 100, two driving portions 110, in detail, a left hip driving portion and a right hip driving portion, may be provided. The controller 140 may output a control signal to control the driving portions 110 to generate torques.

The driving portion 110 may generate a torque based on the control signal output by the controller 140.

In some example embodiments, the driving portions 110 may be provided in plural where each is configured to drive a respective one of the legs of the user, and a plurality of controllers 140 may be provided each configured to control a respective one of the plurality of the driving portions 110. In other example embodiments, a single one of the controller 140 may be designed to control both of the driving portions 110.

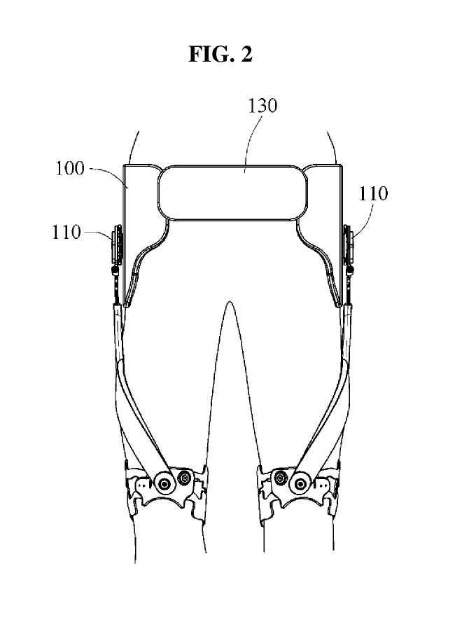

FIG. 3 illustrates another example of a walking assistance device according to at least one example embodiment.

The walking assistance device 100 described with reference to FIGS. 1 and 2 may further include at least one shoe insole 310. Hereinafter, to differentiate between the walking assistance device 100 and a walking assistance device 300 including the shoe insole 310, the waking assistance device 100 may be referred to as a main device 305. Because description of the main device 305 may be substituted for description of the walking assistance device 100 described with reference to FIGS. 1 through 2, detailed description of the main device 305 will be omitted.

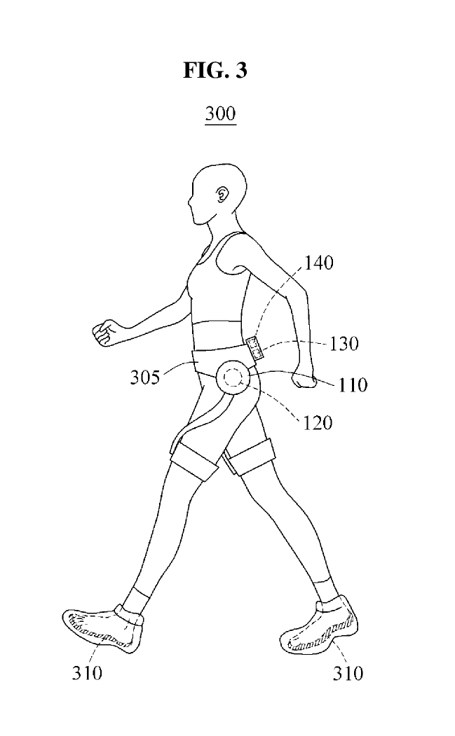

The shoe insole 310 may include a vibration element configured to generate a vibration, and the walking assistance device 300 may transfer information to a user using the vibration element of the shoe insole 310. Detailed description of a method of transferring the information to the user using the vibration element of the shoe insole 310 will be provided with reference to FIGS. 4 through 11.

FIG. 4 is a block diagram illustrating a walking assistance device according to at least one example embodiment.

Referring to FIG. 4, a walking assistance device 400 may be the above-described main device 305, and may provide a user with an assistance force to assist the user with walking.

The walking assistance device 400 includes a communicator 410, a processor 420, a driving portion 430, a storage 440, a joint angle sensor 450, a global positioning system (GPS) 460, and an inertial measurement unit (IMU) 470.

The communicator 410 may be connected to the processor 420, the storage 440, the joint angle sensor 450, the GPS 460, and the IMU 470, and may transmit and receive data. Also, the communicator 410 may be connected to an external device, and may transmit and receive data. The communicator 410 may be implemented as circuitry in the walking assistance device 400. For example, the communicator 410 may include an internal bus or an external bus. In another example, the communicator 410 may be an element configured to connect the walking assistance device 400 and the external device. The communicator 410 may be an interface. The communicator 410 may receive data from the external device, and transmit the data to the processor 420 and the storage 440.

The processor 420 may process data received by the communicator 410 and data stored in the storage 440. The processor 420 may transmit information on a torque to the driving portion 430. The processor 420 may correspond to the above-described controller 140 of FIG. 1.

The processor 420 may be a data processing device implemented as hardware including a circuit having a physical structure for executing desired operations. For example, the desired operations may include a code and instructions included in a program. For example, the data processing device implemented as hardware may include a microprocessor, a central processing unit (CPU), a processor core, a multi-core processor, a multiprocessor, an application-specific integrated circuit (ASIC), and a field programmable gate array (FPGA).

The processor 410 may execute a code, for example, software, to be read by a computer and stored in a memory, for example, the storage 440, and instructions caused by the processor 410.

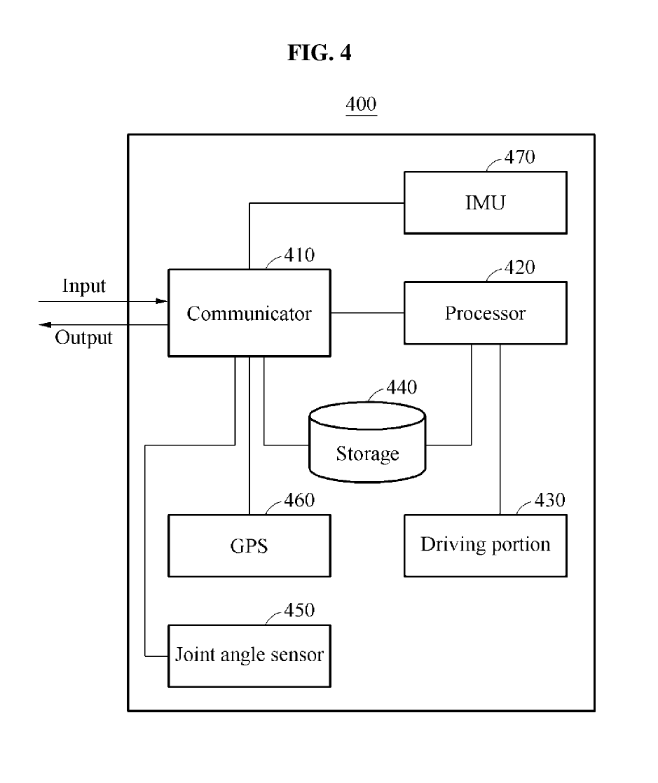

As discussed in more detail below, the computer readable code may configure the processor 410 as a special purpose computer to perform the operations illustrated in one or more of FIGS. 5, 7, 10 and 11 such that the processor 410 is configured to control one or more vibrating elements included in, for example, the shoe insole 310 to haptically provide information to the user regarding, for example, a level and/or timing of assistance torque, an occurrence of an event, and/or progress along a movement route.

The driving portion 430 may operate based on the information on the torque. The driving portion 430 may generate an assistance force through a rotation of a motor. The driving portion 430 may correspond to the driving portion 110 of FIG. 1.

The storage 440 may store the data received by the communicator 410 and the data processed by the processor 420. For example, the storage 440 may store a program.

The storage 440 may be a nonvolatile memory device, a volatile memory device, a non-transitory storage medium, or a combination of two or more of the above-mentioned devices. For example, the storage 440 may include one or more of a Read Only Memory (ROM), Random Access Memory (RAM), Compact Disk-Read Only Memories (CD-ROMs), magnetic tapes, floppy disks, and an optical recording medium.

In an example, the storage 440 may include at least one of a volatile memory and a non-volatile memory, for example, a random access memory (RAM), a flash memory, a hard disk drive, and/or an optical disk drive.

The storage 440 may store an instruction set, for example, software, to operate the walking assistance device 400. The instruction set to operate the walking assistance device 400 may be executed by the processor 410.

The joint angle sensor 450 may measure an angle of a joint of the user. For example, the joint of the user may include a hip joint, a knee joint, and an ankle joint. The joint angle sensor 450 may measure an angular velocity of the hip joint, an angular velocity of the knee joint, and an angular velocity of the ankle joint.

The GPS 460 may detect a position of the walking assistance device 400.

The IMU 470 may measure a change in an orientation of the walking assistance device 400. For example, the IMU 470 may verify a direction of a torso of the user wearing the walking assistance device 400.

FIG. 5 is a flowchart illustrating a method of operating a walking assistance device according to at least one example embodiment.

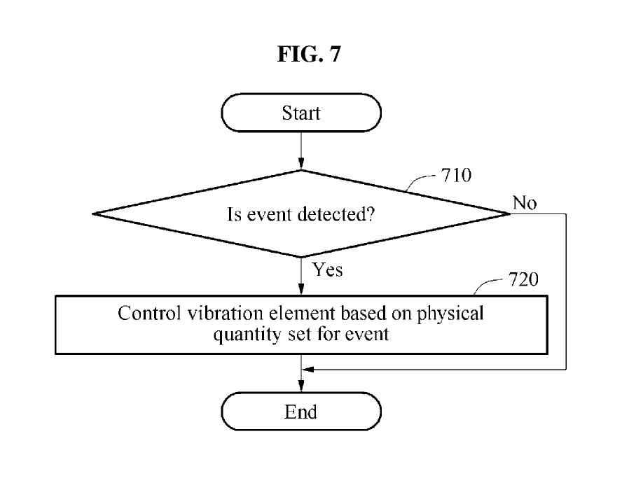

In operation 510, the processor 420 may receive walking information of a user using at least one sensor. In an example, the processor 420 may measure an angle of a joint of a user and an angular velocity of the joint of the user using the joint angle sensor 450. The measured angle and the angular velocity may be the walking information. In another example, the walking information of the user may be received from another device. Detailed description of a method of receiving the walking information from another device will be provided with reference to FIGS. 8 through 10.

In operation 520, the processor 420 may calculate a torque of an assistance force to be provided for the user based on the walking information. For example, the processor 420 may verify a current walking cycle based on the walking information and calculate a torque corresponding to the walking cycle.

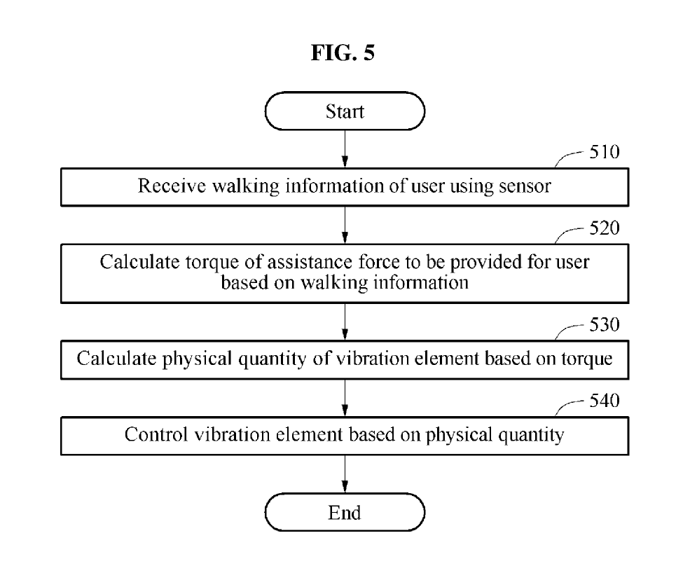

In operation 530, the processor 420 may calculate a physical quantity of a property of at least one vibration element disposed on a sole of the user based on the calculated torque. The property of the physical quantity may include one or more of an amplitude of the vibration and a frequency of the vibration. The processor 420 may calculate the physical quantity to be proportional to a magnitude of the torque. The at least one vibration element may be included in the shoe insole 310, and the vibration element may include a motor. Detailed description of the shoe insole 310 including the at least one vibration element will be provided with reference to FIG. 6.

In operation 540, the processor 420 may control the at least one vibration element based on the physical quantity by, for example, generating a control signal that controls the at least one vibration element. The processor 420 may control the at least one vibration element such that the at least one vibration element operates at a point in time at which the torque is output.

The communicator 410 may transmit the control signal using a wireless local area network to a communicator of the at least one vibration element. For example, the communicator 410 may include a wireless local area network module, for example, a Bluetooth module, but the communicator 410 is not limited thereto. The communicator of the at least one vibration element may apply the control signal received from the communicator 410 to the at least one vibration element.

FIG. 6 illustrates a shoe insole according to at least one example embodiment.

Referring to FIG. 6, a shoe insole 600 may correspond to the shoe insole 310 of FIG. 3.

The shoe insole 600 may include a chip 610 and at least one of vibration elements 620, 622, 624, 626, and 628. Although not illustrated, the shoe insole 600 may further include a battery. The battery may supply a power to the chip 610 and the at least one of the vibration elements 620, 622, 624, 626, and 628. The chip 610 and the at least one of the vibration elements 620, 622, 624, 626, and 628 may be disposed in the shoe insole 600. For example, the vibration element 620 may be disposed in contact with a circular ball beneath a big toe of a foot, and the vibration element 629 may be disposed in contact with a heel of the foot.

The chip 610 may include a controller 612 and a communicator 614.

In some example embodiments, the chip 610 may be implemented as a system-on-chip (SOC) configured to perform a function of the controller 612 and a function of the communicator 614, but the chip 610 is not limited thereto.

The communicator 614 may receive a control signal transmitted from the communicator 410. For example, the communicator 614 may include a wireless local area network module, for example, a Bluetooth module, but the communicator 614 is not limited thereto. The controller 612 may apply the control signal to at least one of the vibration elements 620, 622, 624, 626, and 628.

Each of the vibration elements 620, 622, 624, 626, and 628 may operate based on the calculated physical quantity.

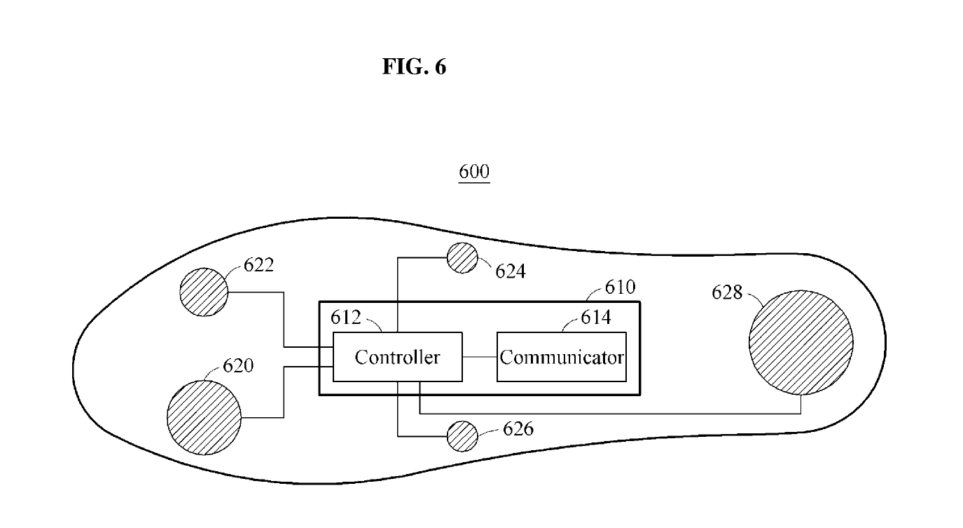

FIG. 7 is a flowchart illustrating a method of controlling a vibration element based on an event according to at least one example embodiment.

Referring to FIG. 7, operations 710 and 720 may be performed in parallel with operations 510 through 540 described with reference to FIG. 5. Operations 710 and 720 may be performed in parallel with any one of operations 510 through 540, that is, even while any one of operations 510 through 540 is being performed. Therefore, as discussed below, the user may be provided with both information regarding the torque of the assistance forced provided by the walking assistance device 300 and information regarding the occurrence of an event.

In operation 710, the processor 420 may detect an event, for example, a preset event. The event may be associated with a state of the walking assistance device 300. In an example, the state of the walking assistance device 300 may be a mode change of the walking assistance device 300, a battery alarm being generated, or an emergency alarm being generated. In another example, the GPS 460 may detect a current position of the walking assistance device 300. The detected position may be a set (or, alternatively, a preset) position. The position may indicate a nonsmoking area, but the position is not limited thereto. In another example, the walking assistance device 300 may include a massage mode. When the user selects the massage mode, the event may be detected.

In operation 720, the processor 420 may control the at least one of the vibration elements 620, 622, 624, 626, and 628 based on a physical quantity set for the detected event when the event is detected. A plurality of different events may be set, and a physical quantity may be set for each of the events.

FIG. 8 illustrates still another example of a walking assistance device according to at least one example embodiment.

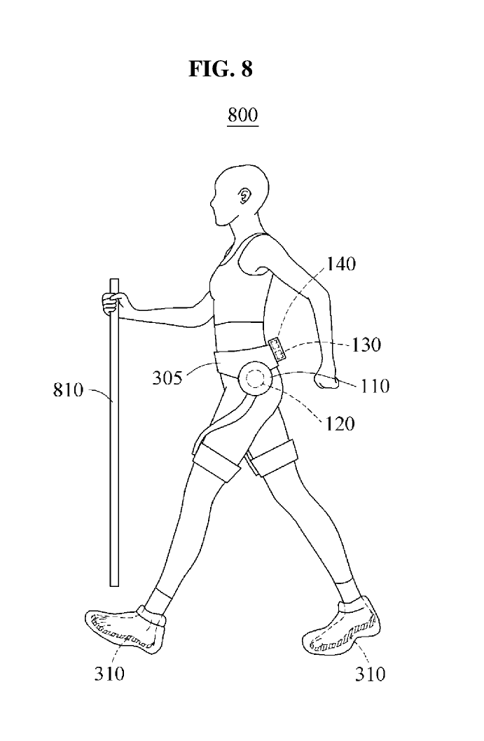

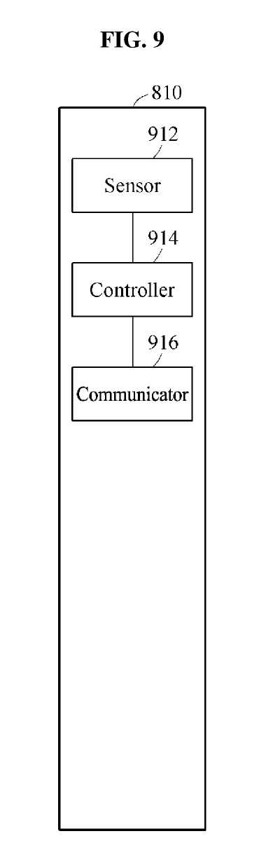

Referring to FIG. 8, an additional device may be included in the walking assistance device 300 described with reference to FIGS. 3 through 6. The additional device may be a device 810 in a form of a stick. A walking assistance device 800 includes the main device 305, the shoe insole 310, and the device 810 in the form of the stick. The device 810 in the form of the stick may be a cane. The device 810 in the form of the stick and the main device 305 may be connected to each other using a wireless local area network. Detailed description of the device 810 in the form of the stick will be provided with reference to FIGS. 9 and 10.

FIG. 9 is a block diagram illustrating a device in a form of a stick according to at least one example embodiment.

Referring to FIG. 9, the device 810 in the form of the stick may include a sensor 912, a controller 914, and a communicator 916.

Although not illustrated, the device 810 in the form of the stick may further include a battery. The battery may supply a power to the sensor 912, the controller 914, and the communicator 916.

The controller 914 may control the sensor 912 and the communicator 916.

In some example embodiments, the sensor 912 may be a pressure sensor. When a user applies a pressure to the sensor 912, the sensor 912 may generate a signal corresponding to the applied pressure. For example, the signal may be generated such that an intensity of the signal is proportional to the applied pressure.

In another example embodiment, the sensor 912 may be a button. When the user presses the button, an activation signal may be generated. When the user releases the button, a de-activation signal may be generated. The activation signal may be generated while the user is pressing the button, or the activation signal may be generated until the user presses the button and then the user presses the button again. The activation signal may be walking information.

In still another example embodiment, the sensor 912 may be disposed at a lowest end of the device 810 in the form of the stick. The sensor 912 may be disposed at a position at which the sensor 912 is to be pressed in response to the user pressing the device 810 in the form of the stick on a ground.

The communicator 916 may transmit the activation signal generated by the sensor 912 to the main device 305. The communicator 916 may transmit the walking information to the main device 305. The communicator 916 may include a wireless local area network module, for example, a Bluetooth module, but the communicator 916 is not limited thereto.

FIG. 10 is a flowchart illustrating a method of receiving walking information using a pressure sensor according to at least one example embodiment.

Referring to FIG. 10, operation 510 described with reference to FIG. 5 may include operations 1010 and 1020.

In operation 1010, the sensor 912 may sense a pressure applied by a user. When the sensor 912 is a button, the sensor 912 may generate an activation signal in response to the button being pressed. The sensed pressure and the activation signal may be walking information.

In operation 1020, the communicator 916 may transmit the walking information to the main device 305. For example, the communicator 916 may transmit the sensed pressure to a communicator of the main device 305.

The controller 420 may control the main device 305 based on the walking information. For example, the controller 420 may control the torque and/or one or more of the vibrating elements 620, 622, 624, 626, and 628 based on the walking information.

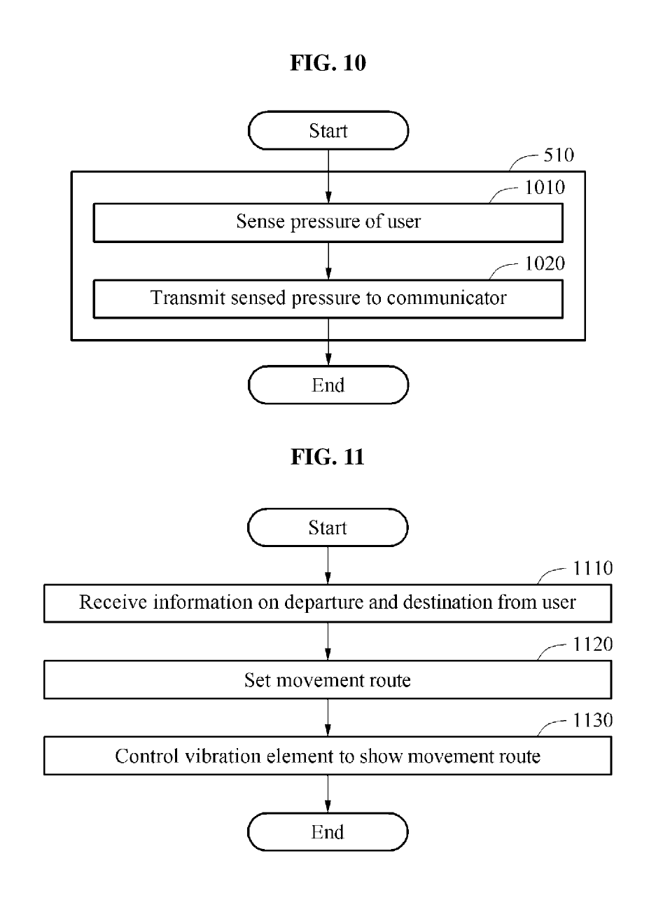

FIG. 11 is a flowchart illustrating a method of controlling a vibration element to show a movement route according to at least one example embodiment.

Referring to FIG. 11, Operations 1110 through 1130 may be performed in parallel with operations 510 through 540 described with reference to FIG. 5.

Operations 1110 through 1130 may be performed in parallel with any one of operations 510 through 540, that is, even while any one of operations 510 through 540 is being performed. Operations 1110 through 1130 may be performed by the walking assistance device 100, 300, 800.

In operation 1110, the processor 320 may receive information on a departure and a destination from a user through a user interface. For example, the user interface may include at least one of a voice recognition interface or a touch panel.

In operation 1120, the processor 420 may set a movement route based on the information on the departure and the destination.

In operation 1130, the processor 420 may control at least one of the vibration elements 620, 622, 624, 626, and 628 to indicate the movement route using the GPS 460. The GPS 460 may detect a current position of the walking assistance device 300. The processor 420 may control at least one vibration element such that the user arrives at the destination based on the current position. The processor 420 may control the at least one vibration element to show the movement route. For example, the processor 420 may control the at least one vibration element based on a preset physical quantity with respect to each of a straight route, a right turn route, and a left turn route.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments.

For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of operating a walking assistance device, the walking assistance device configured to provide an assistance force to assist a user with walking, the method comprising:
calculating a torque of the assistance force based on walking information associated with the user, the walking information being obtained through at least one sensor;
calculating a physical quantity of a property of at least one vibration element based on the torque, the at least one vibration element being proximate to a sole of the user; and
controlling the at least one vibration element based on the physical quantity.

2. The method of claim 1, wherein the property of the physical quantity includes one or more of an amplitude and a frequency of vibration of the at least one vibration element.

3. The method of claim 1, wherein the controlling comprises:
controlling the at least one vibration element via a wireless local area network.

4. The method of claim 1, wherein the at least one vibration element is configured to fit within an insole of a shoe associated with the user.

5. The method of claim 1, wherein the physical quantity is proportional to the torque.

6. The method of claim 1, wherein the walking information includes at least one of information on an angle of a hip joint of the user and information on an angular velocity of the hip joint.

7. The method of claim 1, wherein the controlling comprises:
controlling the at least one vibration element such that the at least one vibration element operates at a point in time at which the torque is output.

8. The method of claim 1, further comprising:
detecting an event; and
controlling the at least one vibration element based on a physical quantity set for the event, if an occurrence of the event is detected.

9. The method of claim 1, wherein the at least one sensor is a pressure sensor.

10. The method of claim 9, wherein
the walking information includes information associating a pressure applied to the pressure sensor by the user and a level of the torque, and
the pressure sensor is included in a walking stick.

11. A non-transitory computer-readable medium comprising computer readable instructions that, when executed by a computer, cause the computer to perform the method of claim 1.

12. A walking assistance device configured to provide an assistance force to assist a user with walking, the walking assistance device comprising:
at least one sensor configured to obtain walking information of a user; and
a processor configured to,
calculate a torque of the assistance force based on the walking information,
calculate a physical quantity of a property of at least one vibration element based on the torque, the at least one vibration element being proximate to a sole of the user, and
control the at least one vibration element based on the physical quantity.

13. The walking assistance device of claim 12, further including:
a shoe insole, the at least one vibration element being configured to fit within the shoe insole.

14. The walking assistance device of claim 12, wherein the physical quantity is proportional to the torque.

15. The walking assistance device of claim 12, wherein the processor is configured to control the at least one vibration element such that the at least one vibration element operates at a point in time at which the torque is output.

16. The walking assistance device of claim 12, wherein the processor is configured to detect an event, and to control the at least one vibration element based on a physical quantity set for the event, if an occurrence of the event is detected.

17. The walking assistance device of claim 12, wherein the at least one sensor is a pressure sensor.

18. The walking assistance device of claim 17, further comprising:
a walking stick including the pressure sensor, and wherein
the walking information associating a pressure applied to the pressure sensor by the user and a level of the torque.

19. The walking assistance device of claim 12, further comprising:
a global positioning system (GPS), wherein
the processor is configured to set a movement route based on the GPS, and to control the at least one vibration element to indicate the movement route.

20. A walking assistance device comprising:
a walking stick including a pressure sensor configured to detect a pressure applied by a user;
a shoe insole including the at least one vibration element; and
a processor configured to,
calculate a torque of an assistance force to be provided for the user based on the pressure,
calculate a physical quantity of a property of the at least one vibration element based on the torque, and
control the at least one vibration element based on the physical quantity.
